(19) United States
(12) Patent Application Publication
(10) Pub. No.: US 2014/0259135 A1
(43) Pub. Date: Sep. 11, 2014

(54) METHOD AND SYSTEM FOR SIMPLIFIED USER REGISTRATION ON A WEBSITE

(71) Applicant: SIGNATURE SYSTEMS LLC, Miami Beach, FL (US)

(72) Inventor: Richard Postrel, Miami Beach, FL (US)

(73) Assignee: SIGNATURE SYSTEMS LLC, Miami Beach, FL (US)

(21) Appl. No.: 13/790,255

(22) Filed: Mar. 8, 2013

(51) Int. Cl. H04L 29/06

(52) U.S. Cl. CPC H04L 63/08
USPC 726/7

(57) ABSTRACT

A method and system for providing secure registration with a target website computer in which a user logs into a trusted partner website computer, which returns a link to the target website computer. The user computer is redirected to the target website computer with a token that identifies the user computer as being registered with and originating from the trusted partner website computer. After verification, the user provides registration information including an email address to the target website computer, which then sends a registration email message including a unique registration code to the email address provided by the user. The user computer displays a popup window that provides the unique registration code for viewing by the user. The user populates the registration code into a form on a registration verification web page which is sent to the target website computer for verification and completion of the user registration process.

### BACKGROUND OF THE INVENTION

This invention relates to registration of users with websites, and in particular to a streamlined process that provides security and ease of use.

Registration of a user with a website has become an increasingly complex task. Security measures are commonly used in order to ensure that users attempting to register are legitimate human beings, and not an automated process know as a bot. In the prior art, a common security measure is for the website to send an email message to the user who is attempting to register. This ensures that the user has provided a legitimate email address for subsequent communications with the website. After the user receives this message, he is required to enter a unique registration code into a field on a web page. This can be a very inconvenient process, in particular for a user who is using a smartphone device. Since the display space on a smartphone is limited, and simultaneous windows are not provided for, the user must constantly switch applications to retrieve the email message, get the registration code, and then switch back to the web page to enter the code and complete the registration process. The present invention addresses this problem as will be described herein.

### SUMMARY OF THE INVENTION

The present invention is a method of providing secure registration of a user with a website referred to as a target website, when that user has been referred to the website from another website referred to as a trusted third party partner website. The basis for the registration security is that the user is already registered with a known third party website that is trusted by the target website, through for example a partnering arrangement. In one example, the trusted third party website is a loyalty program such as HILTONHONORS. The user is already a member of the HILTONHONORS loyalty program, and has also previously registered with the HILTONHONORS website.

First, the user logs into the HILTONHONORS trusted partner website computer by providing this or her login credentials for HILTONHONORS, which would typically include a user name and login password. The trusted partner website computer HILTONHONORS verifies the identity of the user by checking the login credentials as well known in the art (e.g. by a database lookup).

At some point while the user is browsing the HILTONHONORS website, he may be provided with a link, such as in an advertisement, that will invite him to click through and be redirected to the target website. For example, the target website may be an ecommerce site such as the SWIFT EXCHANGE website, which in this example is a trusted partner of HILTONHONORS. The user selects the link to the target website, and the user computer is redirected to the target website by the link from the trusted partner website. The redirection will include a unique secure token that identifies the user computer as being registered with and originating from the trusted partner website. For example, the token may be a unique data string encoded with the identity of the originating trusted partner website (i.e. HILTONHONORS). In this manner, the target website computer can identify which trusted third partner has referred the user for subsequent reconciliation processes.

When the target website computer receives the redirect request, it will also receive the token from the user computer. The target website computer can then check the token to verify its authenticity and that the user has therefore been referred by a trusted partner website. For example, the token may be checked against a target website computer database of unique tokens to make sure it is valid. Or, the token may be parsed to retrieve the identifier of the referring trusted partner website, and that identifier can be checked for authenticity.

Assuming that the token has been verified, then the target website computer requests the user computer to provide registration information, such as name, address, and an email address of the user. After the target website computer receives this registration information, it sends a registration email message to the email address provided by the user. This registration email message includes a unique registration code generated for one-time use in this situation.

The registration email message is received by the user computer, and a popup window is displayed on the screen of the user computer. The popup window displays the unique registration code from the registration email message received from the target website computer. The user sees this registration code, and then can easily enter it into a form on a web page and send that web page to the target website computer. The target website computer then verifies the registration code and completes the user registration process.

In order for the user computer to be able to display the popup window with the registration code, the target website computer sends a beacon web page to the user computer. The beacon web page includes a client-side beacon application that scans email messages arriving at the user computer and displays the popup window on the screen of the user computer of the registration email message sent by the target website computer. The beacon web page may include a permission request control selectable by the user computer, which when selected enables the client-side beacon application to scan the email messages arriving at the user computer. Optionally, the client-side beacon application remains enabled for a predetermined amount of time. The client-side beacon application may scan email messages arriving at the user computer by searching for a unique marker embedded in the registration email message sent by the target website computer. The unique marker may for example be an originating email address of the email message sent by the target website computer, or it may be embedded in a subject line of the email message sent by the target website computer.

As such, this methodology enables a user to easily view the registration email message from the target website computer without having to switch applications from the web browser program, and then enter the displayed code to complete the registration process.

Thus, as explained in detail below, the present invention from the overall system perspective comprises a method of providing secure registration with a target website computer comprising a user operating a user computer logging into a trusted partner website computer via a computer network by providing trusted partner login credentials; the trusted partner website computer verifying the user by checking the trusted partner login credentials; the trusted partner website computer sending a webpage to the user computer comprising a link to a target website computer; the user computer selecting the link to the target website computer; the user computer being redirected to the target website computer by the link from the trusted partner website computer, the redirection including a unique secure token that identifies the user computer as being registered with and originating from the trusted partner website computer; the user computer sending to the target website computer the unique security token; and the target website computer using the token to verify that the user computer was redirected from the trusted partner website computer. If the target website computer verifies that the user computer was redirected from the trusted partner website computer, then the method continues to perform the steps of the target website computer requesting the user computer to provide registration information, the user computer sending the requested registration information to the target website computer, the requested registration information comprising an email address of the user, the target website computer sending a registration email message to the email address provided by the user, the registration email message including a unique registration code, the user computer displaying a popup window on a screen of the user computer, the popup window providing the unique registration code for viewing by the user, the user populating the registration code into a form on a registration verification web page and sending the registration verification web page to the target website computer, and the target website computer verifying the registration code and completing the user registration process.

From the perspective of the target website computer, the invention comprises a method of providing secure registration with a target website computer comprising a target website computer receiving from a user computer a unique security token that identifies the user computer as being registered with and originating from a trusted partner website computer with which the user computer has previously logged in with trusted partner login credentials, and the target website computer using the token to verify that the user computer was redirected from the trusted partner website computer. If the target website computer verifies that the user computer was redirected from the trusted partner website computer, then the target website computer continues to perform the steps of requesting the user computer to provide registration information, receiving from the user computer the requested registration information, the requested registration information comprising an email address of the user, sending a registration email message to the email address provided by the user, the registration email message including a unique registration code, receiving from the user computer a registration verification web page populated at the user computer with the unique registration code as a result of the user computer displaying a popup window on a screen of the user computer, the popup window providing the unique registration code for viewing by the user, and verifying the registration code and completing the user registration process.

From the perspective of the trusted partner website computer, the invention comprises a method of providing secure registration with a target website computer comprising: a trusted partner website computer receiving trusted partner login credentials from a user operating a user computer for logging into the trusted partner website computer; the trusted partner website computer verifying the user by checking the trusted partner login credentials; and the trusted partner website computer sending a webpage to the user computer comprising a link to a target website computer to enable the user computer to select the link to the target website computer and be redirected to the target website computer, the redirection including a unique secure token that identifies the user computer as being registered with and originating from the trusted partner website computer.

From the perspective of the user computer, the invention comprises a method of a user computer establishing secure registration with a target website computer comprising a user operating a user computer logging into a trusted partner website computer via a computer network by providing trusted partner login credentials; the user computer receiving from the trusted partner website computer, after the trusted partner website computer has verified the user by checking the trusted partner login credentials, a webpage comprising a link to a target website computer; the user computer selecting the link to the target website computer; the user computer being redirected to the target website computer by the link from the trusted partner website computer, the redirection including a unique secure token that identifies the user computer as being registered with and originating from the trusted partner website computer; the user computer sending to the target website computer the unique security token for verification that the user computer was redirected from the trusted partner website computer; the user computer receiving a request from the target website computer for the user computer to provide registration information, the user computer sending the requested registration information to the target website computer, the requested registration information comprising an email address of the user, the user computer receiving a registration email message at the email address provided by the user, the registration email message including a unique registration code, the user computer displaying a popup window on a screen of the user computer, the popup window providing the unique registration code for viewing by the user, and the user populating the registration code into a form on a registration verification web page and sending the registration verification web page to the target website computer for verification and completion of the user registration process.

In the embodiment summarized above, there is a pre-existing business relationship between the target website and the trusted partner website, such that the target website trusts the trusted partner website when the trusted partner website refers (redirects) the user to the target website. In an alternative embodiment, a trusted third party service provides trust brokering for any party with which it is affiliated. That is, there need not be a direct pre-existing relationship between the target website and the originating website, as long as the target website has a trust relationship with the trusted third party service and the originating website has a trust relationship with the trusted third party service. In this alternative embodiment, a user operating a user computer logs into an originating website computer via a computer network by providing originating website login credentials. The originating website computer verifies the user by checking the originating website login credentials, and then sends a webpage to the user computer comprising a link to a target website computer. The user computer selects the link to the target website computer and is redirected to the target website computer by the link from the trusted partner website computer, the redirection including a unique secure token that identifies the user computer as being registered with and originating from the originating website computer. The user computer sends to the target website computer the unique security token and the target website computer uses the token to verify that the user computer was redirected from the trusted partner website computer. This is accomplished by sending a user verification query (including the token) to a trusted third party service computer. The trusted third party service computer uses the token to verify that the user computer was redirected from the trusted partner website computer and then sends a user verification confirmation message to the target website computer.

If the target website computer verifies that the user computer was redirected from the trusted partner website computer, then the target website computer requests the user computer to provide registration information. The user computer sends the requested registration information (an email address of the user) to the target website computer. The target website computer sends a registration email message to the email address provided by the user, the registration email message including a unique registration code. The user computer displays a popup window on a screen of the user computer, the popup window providing the unique registration code for viewing by the user. The user populates the registration code into a form on a registration verification web page and sends the registration verification web page to the target website computer. The target website computer verifies the registration code and completes the user registration process.

### BRIEF DESCRIPTION OF THE DRAWING

FIG. 1 is a flowchart of the main data flow of the preferred embodiment of the present invention;

FIG. 1A is a flowchart of the process that branches from point A in FIG. 1 that illustrates the algorithm for implementing the pop-up email display;

FIG. 2 is a system block diagram of the preferred embodiment of the present invention;

FIG. 3 is an illustration of a web form that requests entry of the registration code as used in the preferred embodiment of the present invention;

FIG. 4 is an illustration of the web form of FIG. 3 with a pop up window displayed;

FIG. 5 is an illustration of the web form of FIG. 3 with a pop up window displayed and the registration code populated;

FIG. 6 is an illustration of a web page that indicated completion of the registration process;

FIG. 7 illustrates a system block diagram of an alternative embodiment; and

FIG. 8 is a flowchart of the process flow of an alternative embodiment of the present invention.

### DETAILED DESCRIPTION OF THE PREFERRED EMBODIMENT

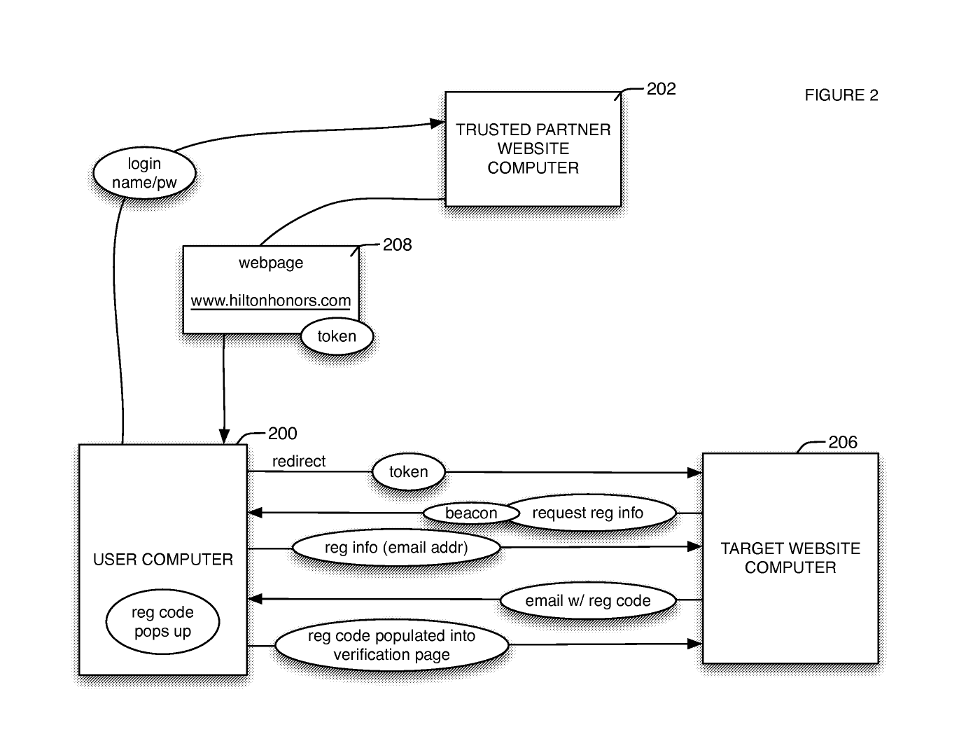

FIG. 2 illustrates a system block diagram of the preferred embodiment of the present invention. The system includes a user computer 200 which is operated by a user, a trusted partner website computer 202 that is interconnected via a computer network (not shown) with the user computer 200, and a target website computer 206 that is interconnected via the computer network with the user computer 200.

The user computer 200 may be any type of well known computing device such as a desktop computer, laptop computer, mobile computer, smartphone, tablet, and the like. The present invention finds exemplary usefulness and applicability when the user computer 200 is a smartphone such as an IPHONE or ANDROID device, since a smartphone has a limited display area. However, although the examples herein are provided with respect to a smartphone, the present invention is not limited to use on a smartphone. The user computer 200 typically includes a housing, display screen, power source, input devices such as buttons and a touchscreen, output devices such as a display screen (e.g. the touchscreen) and a speaker, wireless (and/or wired) network communications circuitry, processing circuitry, program storage, and data memory, all as well known in the art. The user computer will execute browser software in order to communicate with the trusted partner website computer 202 and the target website computer 206 over the computer network such as the Internet, as well known n the art.

The trusted partner website computer 202 is typically a server computer that is configured for executing web server software and communicating over a computer network such as the Internet (not shown). The trusted partner website computer 202 thus will typically have a housing, display screen, power source, input devices such as buttons and a keyboard, output devices such as a display screen, wireless (and/or wired) network communications circuitry, processing circuitry, program storage, and data memory, all as well known in the art. The trusted partner website computer 202 will be programmed to perform the steps of the present invention as will be described herein.

The target website computer 206 is also typically a server computer that is configured for executing web server software and communicating over a computer network such as the Internet (not shown). The target website computer 206 thus will typically have a housing, display screen, power source, input devices such as buttons and a keyboard, output devices such as a display screen, wireless (and/or wired) network communications circuitry, processing circuitry, program storage, and data memory, all as well known in the art. The target website computer 206 will be programmed to perform the steps of the present invention as will be described herein.

The trusted partner website computer 202 is considered to be trusted by the target website 206 since the entity that operates the trusted partner website computer 202 (the trusted entity) will have established some type of business relationship with the entity that operates the target website computer 206 (the target entity). For example, the trusted entity may be Hilton Hotels, which operates the HILTONHONORS loyalty program, and the target entity may be SWIFT EXCHANGE, which operates an e-commerce website where users may execute various transactions such as searching for and purchasing products and services, use loyalty points to pay for such products and services, combine and aggregate loyalty points if desired, and the like. Assuming that HILTONHONORS is a trusted partner of SWIFT EXCHANGE, then SWIFT EXCHANGE will accept the validity of a user who is already registered with HILTONHONORS when that user would like to register with SWIFT EXCHANGE. This may occur if the user is viewing the HILTONHONORS website and comes across a link that invites him or her to view and register with the SWIFT EXCHANGE website for more beneficial e-commerce opportunities. As such, SWIFT EXCHANGE is considered to be the target website because the user is redirected to SWIFT EXCHANGE as described below.

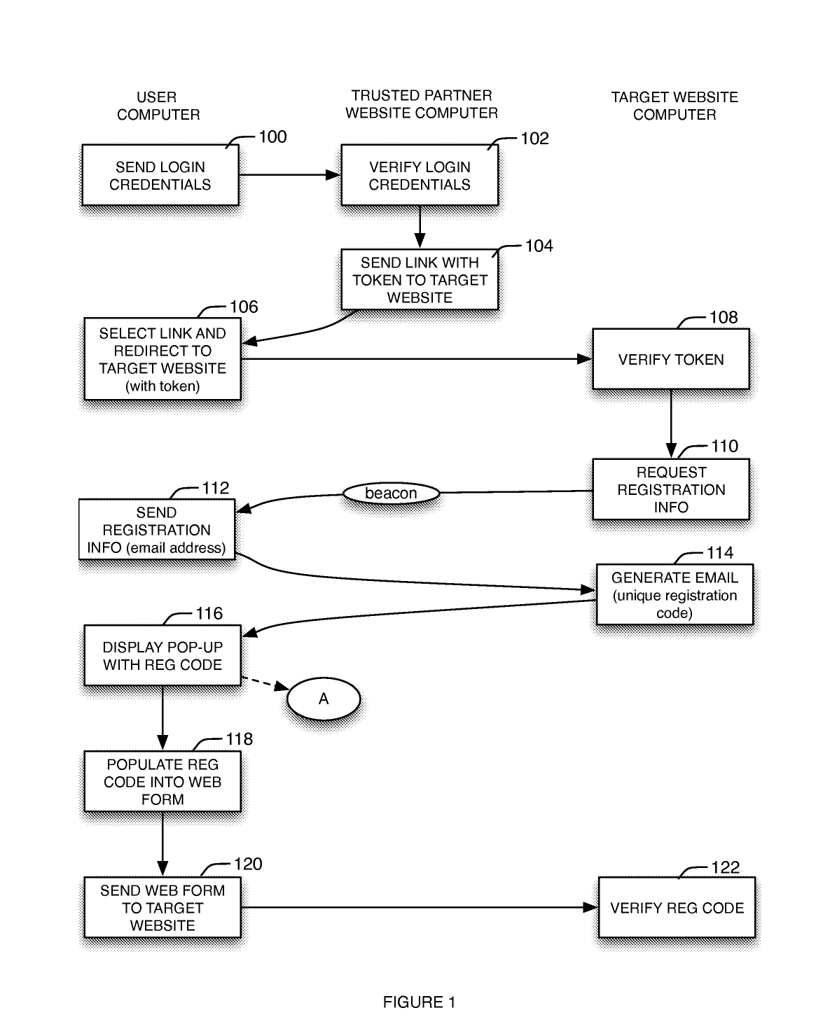

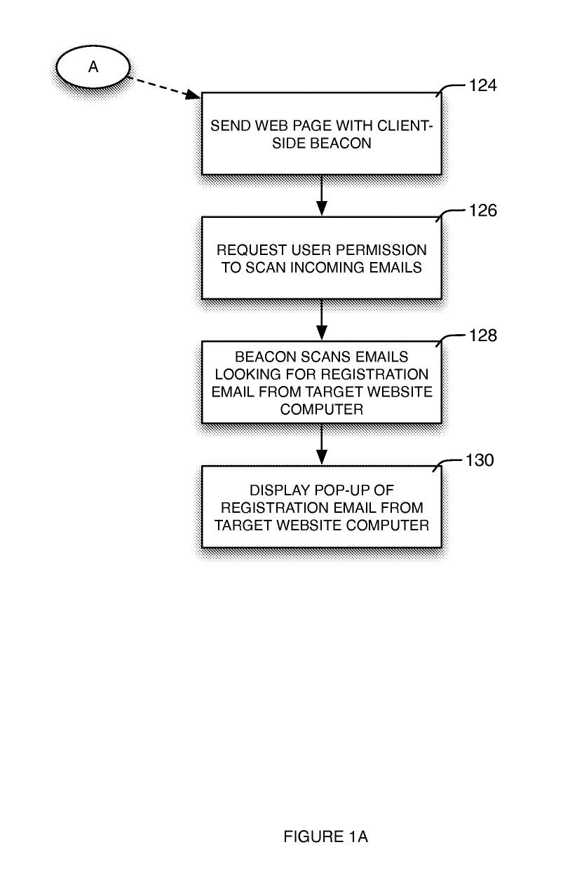

Reference is now made to FIG. 1, which provides the process flow of the preferred embodiment of the present invention. At step 100, the user is viewing the trusted partner website on his user computer 200. He may be presented with a login webpage as well known in the art, where he will provide trusted partner login credentials such as his user name and password. In an alternative embodiment, the user may provide biometric information such as by use of a fingerprint scanner that is attached to or integral with the user computer 200. Or, the user may provide other biometric information such as with a DNA reading device or the like. In any event, the user computer 200 sends the user's login credentials to the trusted partner website computer 202 at step 100 of FIG. 1. At step 102, the trusted partner website computer 202 receives the login credentials and verifies them, typically by reference to a database as known in the art. After the user is verified by the trusted partner website computer 202, then the user may navigate through the trusted partner website as known in the art.

At some point during the user's navigation of the trusted partner website, the user computer will be served at step 104 with a webpage that will contain some sort of link to the target website. This may be in the form of an advertisement that invites the user to click through in order to peruse and join the target website. Once the user clicks on the link to the target website, the user computer 200 will be redirected to the target website computer 206 at step 106 as well known in the art of Internet navigation. As part of this redirection, a unique secure token provided by the trusted partner website computer 202 will be sent from the user computer 200 to the target website computer 206. This token is generated by the trusted partner website computer 202 for the user and identifies the user and user computer as being registered with and originating from the trusted partner website computer 202.

The user computer 200 communicates accordingly with the target website computer 206, which receives the token and performs at step 108 a verification process to verify that the user computer 200 was redirected from the trusted partner website computer 202.

This verification process may be done by checking the token against a database of valid tokens. This token database will have a list of all of the trusted partner websites with which the target website has already agreed to accept their users for this registration process. For example, SWIFT EXCHANGE, as the target website, may have agreements in place with the following trusted partner websites: HILTONHONORS, CITIBANK, AMERICAN EXPRESS, VISA, MASTERCARD, BEST BUY, TAGRTGET, etc.

The tokens from these trusted partners would be stored in the token database at the target website computer 206 for this verification process. In an alternative embodiment, the target website may perform a hash analysis on the token as known in the art.

Optionally, the unique data string of the token may be encoded with an identifier of the trusted partner website computer. This would allow the target website computer 206 to log the identifier of the trusted partner website computer in a transaction database.

If the target website computer 206 verifies at step 108 that the user computer 200 was redirected from the trusted partner website computer 202, then the target website computer 206 proceeds at step 110 to request the user computer 200 to provide certain registration information, which will include at least an email address of the user that is accessible by the user computer 200. That is, in order for the rest of the process to continue successfully, the target website computer needs to have an email address of the user for which the user computer 200 can automatically receive emails (i.e. is logged in to).

At step 112 the user sends to the target website computer 206 the requested email address and other requested registration information. At step 114 the target website computer 206 receives the requested registration information including the email address of the user, and then generates and sends a registration email message to the email address provided by the user. This registration email message includes a unique registration code.

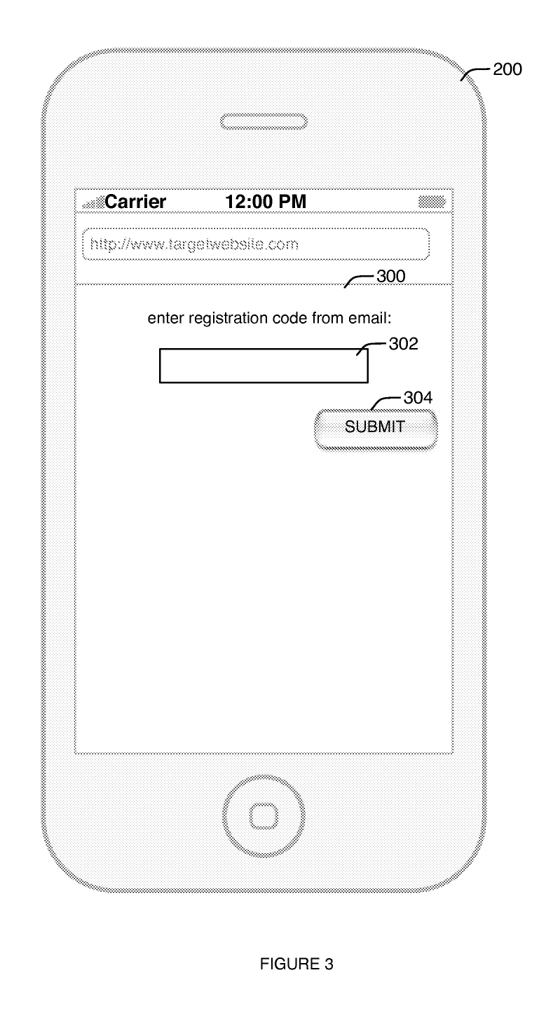

As shown in FIG. 3, the user computer 200 is a smartphone, and is displaying a registration verification web page 300 that it has received from the target website computer 206 after providing the requested registration information. This registration web page 300 includes a data entry field 302 that invites the user to enter the unique registration code as will be described below.

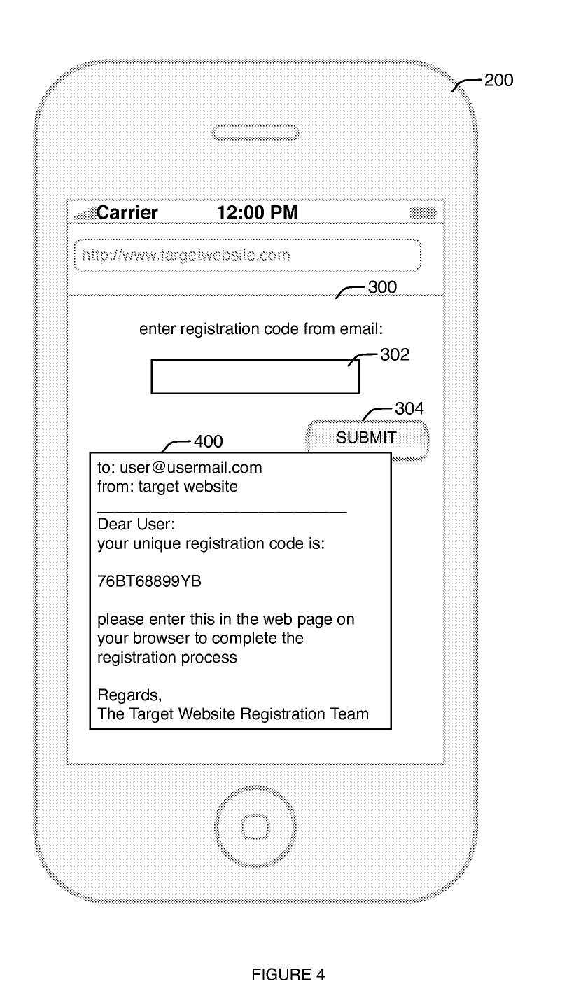

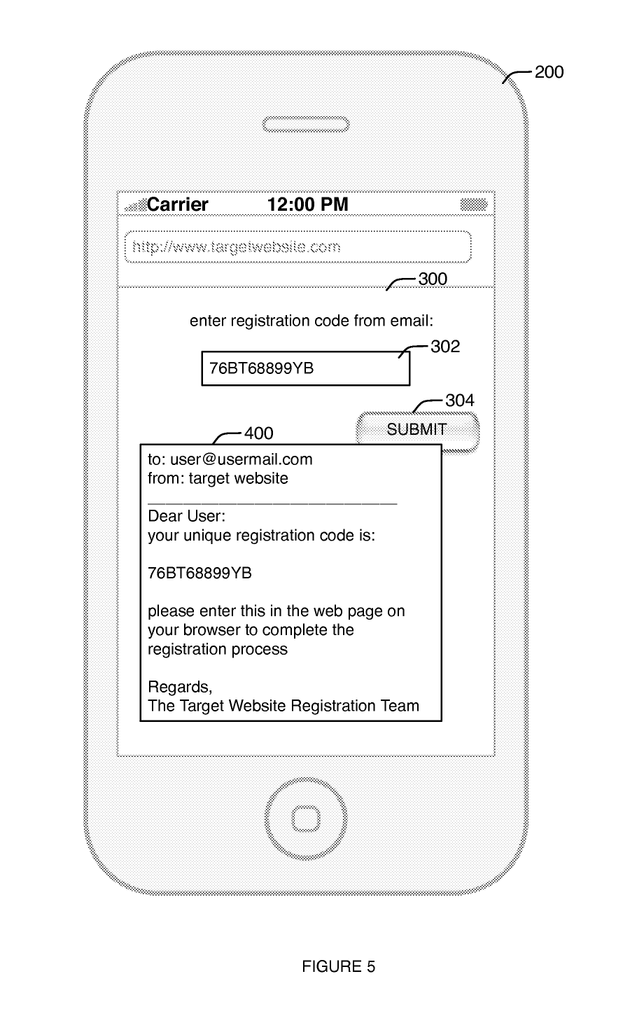

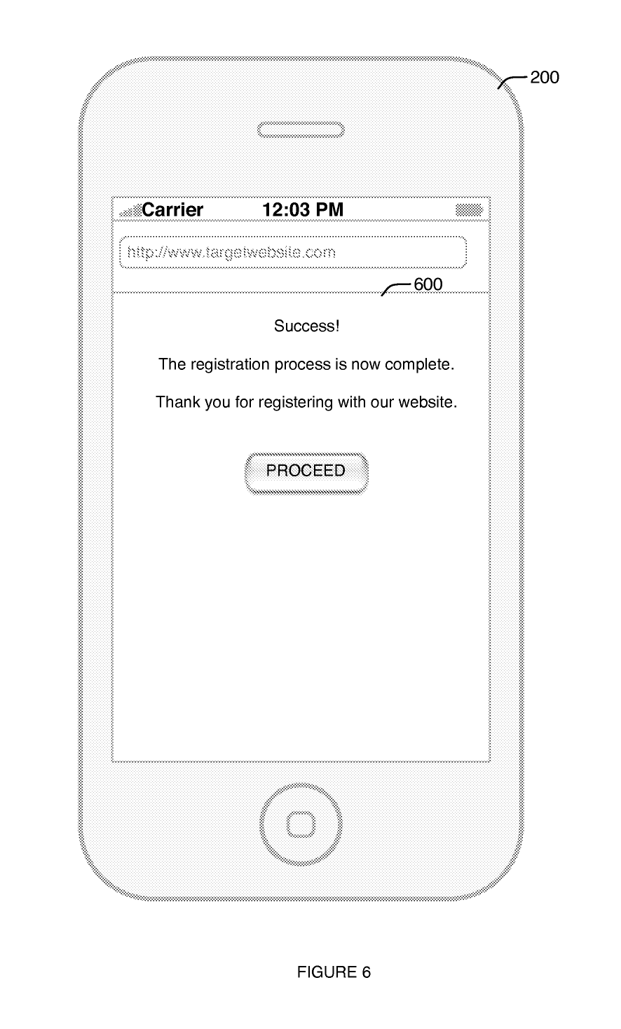

In order for the user to have quick and easy access to the email message with the unique registration code provided by the target website computer 206 in the email message to the user, at step 116 the user computer will be caused to display a popup window on its screen, which provides the unique registration code for viewing by the user. This is shown for example, in FIG. 4, in which popup window 400 displays the email message received from the target website computer 206. This email message prompts the user to populate at step 188 the unique registration code (76BT68899YB) into the data entry field 302 (see FIG. 5). The user then presses the Submit button 304, and the registration verification web page that has been populated with the registration code by the user is sent to the target website computer 206 at step 120. At step 122, the target website computer 206 verifies the registration code and completes the user registration process. A confirmation message 600 may then be provided to the user computer 200 as shown in FIG. 6.

With reference to FIG. 1A, the process for displaying the popup window is now described. At step 124, a web page may be sent by the target website computer 206 to the user computer 200 that includes a client-side beacon. The beacon is a client-side program that executes in the web browser of the user computer. This web page may be the same web page as the registration information form that requests the user to provide his email address as described above, or it may be a separate page sent an any appropriate time during this process. For example, a scripting language such as JAVASCRIPT may be used to execute the functionality described herein. Or, in the alternative, the user may be prompted to download an application from the target website computer that would assist in the registration process, including but not limited to performing the functionality of the beacon as described herein.

At step 126, a request is made to the user for permission for the beacon to scan the user's incoming email messages to look for the registration email message that will be sent by the target website computer 206. The request may be a question presented on the web page with an option to check a box or click a radio button to provide the user's permission. The permission may be limited to a certain time period, such as one minute, thus providing the user with security that the email scanning will be limited. If the user does not give permission then the process terminates.

Assuming that the user grants permission for the beacon to scan his email messages, then at step 128 the beacon proceeds to scan the incoming email messages to look for the registration email message that is being sent by the target website computer 206 in step 114 as described above. This may be done by searching for a unique marker embedded in the registration email message sent by the target website computer 206. For example, the unique marker may be the originating email address of the email message sent by the target website computer 206. Or, the unique marker may be embedded in a subject line of the email message sent by the target website computer, etc. The beacon may interact with a client email program operating on the user computer such that the beacon is given access to the emails being received by the client program.

Once the beacon has found the registration email message, it may then display a popup window at step 130 to enable the user to easily view the registration code and enter it into the web page as described above with respect to step 118.

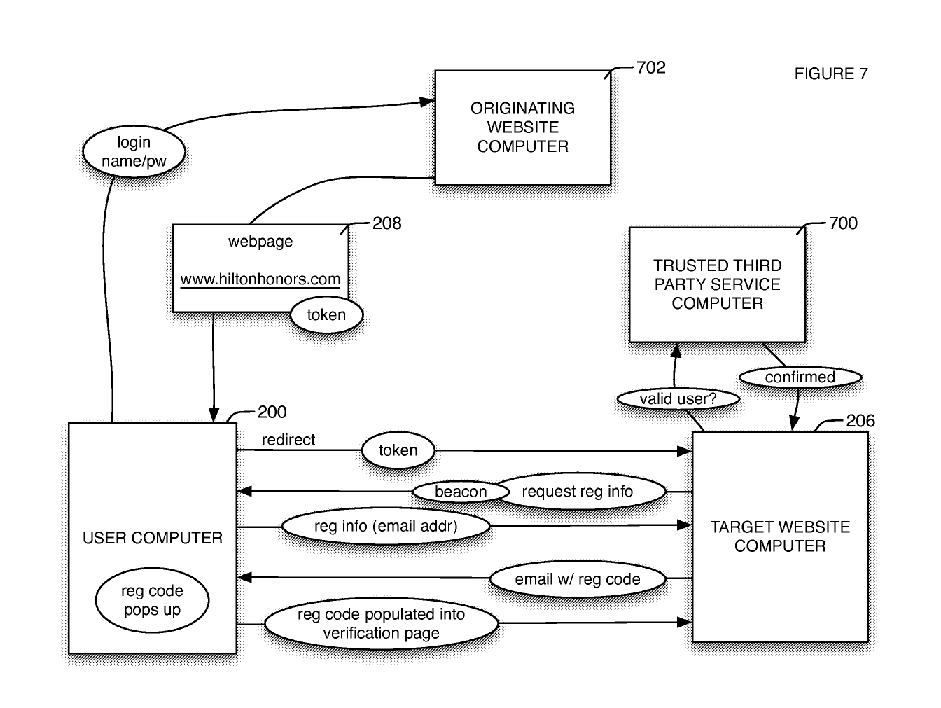

FIG. 7 illustrates a system block diagram of an alternative embodiment. The system includes a user computer 200 which is operated by a user, an originating website computer 702 that is interconnected via a computer network (not shown) with the user computer 200, a target website computer 206 that is interconnected via the computer network with the user computer 200, and a trusted third party service computer 700 that is interconnected via the computer network with the target website computer 206.

The trusted third party service computer 700 is considered to be trusted by the target website 206 since the entity that operates the trusted third party service computer 700 (the trusted entity) will have established some type of business relationship with the entity that operates the target website computer 206 (the target entity). Similarly, the originating website computer 702 is considered to be trusted by the trusted third party service computer 700 since the entity that operates the trusted third party service computer 700 (the trusted entity) will have established some type of business relationship with the entity that operates the originating website computer 702 (the originating entity).

Assuming that HILTONHONORS is a trusted partner of the trusted third party service and that the trusted third party service is a trusted partner of the target website SWIFT EXCHANGE, then SWIFT EXCHANGE will accept the validity of a user who is already registered with HILTONHONORS when that user would like to register with SWIFT EXCHANGE, assuming that the trusted third party service computer confirms the validity of that user. This may occur if the user is viewing the HILTONHONORS website and comes across a link that invites him or her to view and register with the SWIFT EXCHANGE website for more beneficial e-commerce opportunities. As such, SWIFT EXCHANGE is considered to be the target website because the user is redirected to SWIFT EXCHANGE as described below.

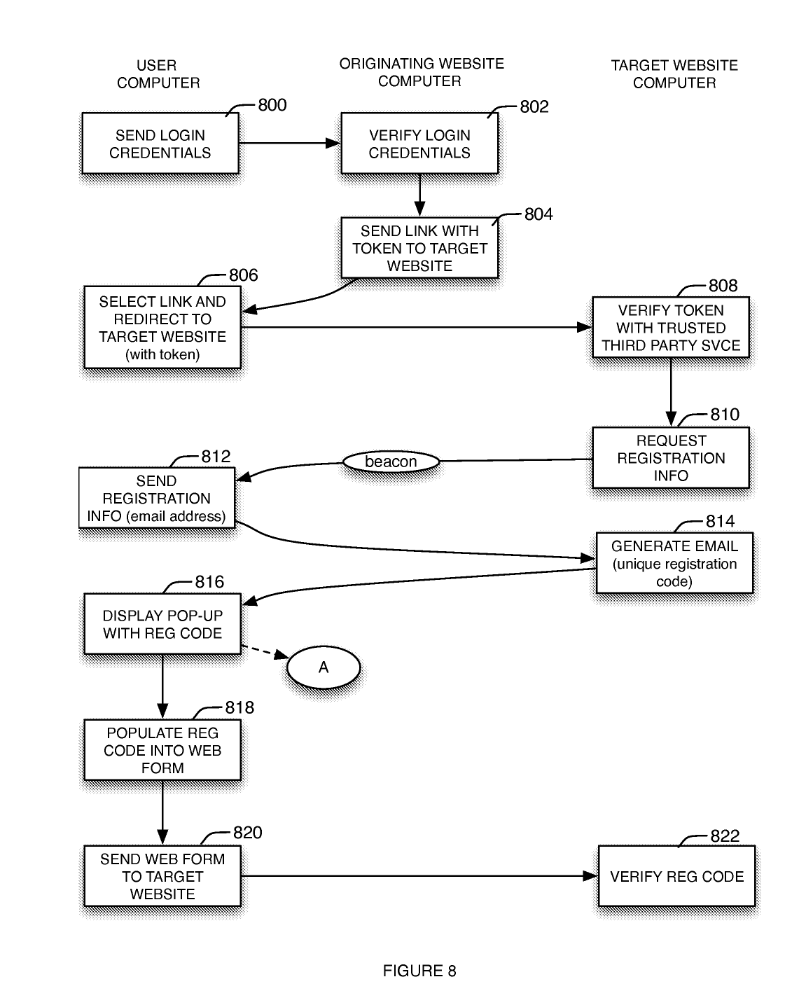

Reference is now made to FIG. 8, which provides the process flow of an alternative embodiment of the present invention. At step 800, the user is viewing the originating website on his user computer 200. He may be presented with a login webpage as well known in the art, where he will provide originating website login credentials such as his user name and password. In an alternative embodiment, the user may provide biometric information such as by use of a fingerprint scanner that is attached to or integral with the user computer 200. Or, the user may provide other biometric information such as with a DNA reading device or the like. In any event, the user computer 200 sends the user's login credentials to the originating website computer 702 at step 100 of FIG. 7. At step 802, the originating website computer 702 receives the login credentials and verifies them, typically by reference to a database as known in the art. After the user is verified by the originating website computer 702, then the user may navigate through the originating website as known in the art.

At some point during the user's navigation of the originating website, the user computer will be served at step 804 with a webpage that will contain some sort of link to the target website. This may be in the form of an advertisement that invites the user to click through in order to peruse and join the target website. Once the user clicks on the link to the target website, the user computer 200 will be redirected to the target website computer 206 at step 806 as well known in the art of Internet navigation. As part of this redirection, a unique secure token provided by the originating website computer 702 will be sent from the user computer 200 to the target website computer 206. This token is generated by the originating website computer 202 for the user and identifies the user and user computer as being registered with and originating from the originating website computer 702.

The user computer 200 communicates accordingly with the target website computer 206, which receives the token and performs at step 808 a verification process in association with the trusted third party service computer 700 to verify that the user computer 200 was redirected from the originating website computer 702. To accomplish this, the target website computer 206 sends a user verification query that includes the token to the trusted third party service computer 700. The trusted third party service computer 700 uses the token to verify that the user computer 200 was redirected from the originating website computer 702. Then, the trusted third party service computer 700 sends a user verification confirmation message to the target website computer 206.

The user verification process may be done by the trusted third party service computer 700 checking the token against a database of valid tokens. This token database will have a list of all of the originating websites with which the trusted third party service computer 700 has already agreed to accept their users for this registration process. For example, the trusted third party service computer 700 may have agreements in place with the following originating websites: HILTONHONORS, CITIBANK, AMERICAN EXPRESS, VISA, MASTERCARD, BEST BUY, TAGRTGET, etc. The tokens from these originating websites would be stored in the token database at the trusted third party service computer 700 for this verification process. In an alternative embodiment, the trusted third party service computer 700 may perform a hash analysis on the token as known in the art.

Optionally, the unique data string of the token may be encoded with an identifier of the originating website computer. This would allow the trusted third party service computer 700 to log the identifier of the originating website computer in a transaction database.

If the user has been thusly verified, then the target website computer 206 proceeds at step 810 to request the user computer 200 to provide certain registration information, which will include at least an email address of the user that is accessible by the user computer 200. That is, in order for the rest of the process to continue successfully, the target website computer needs to have an email address of the user for which the user computer 200 can automatically receive emails (i.e. is logged in to).

At step 812 the user sends to the target website computer 206 the requested email address and other requested registration information. At step 814 the target website computer 206 receives the requested registration information including the email address of the user, and then generates and sends a registration email message to the email address provided by the user. This registration email message includes a unique registration code.

As shown in FIG. 3, the user computer 200 is a smartphone, and is displaying a registration verification web page 300 that it has received from the target website computer 206 after providing the requested registration information. This registration web page 300 includes a data entry field 302 that invites the user to enter the unique registration code as will be described below.

In order for the user to have quick and easy access to the email message with the unique registration code provided by the target website computer 206 in the email message to the user, at step 816 the user computer will be caused to display a popup window on its screen, which provides the unique registration code for viewing by the user. This is shown for example, in FIG. 4, in which popup window 400 displays the email message received from the target website computer 206. This email message prompts the user to populate at step 188 the unique registration code (76BT68899YB) into the data entry field 302 (see FIG. 5). The user then presses the Submit button 304, and the registration verification web page that has been populated with the registration code by the user is sent to the target website computer 206 at step 120. At step 822, the target website computer 206 verifies the registration code and completes the user registration process. A confirmation message 600 may then be provided to the user computer 200 as shown in FIG. 6.

The process for displaying the popup window is described with respect to FIG. 1A in the preferred embodiment above, and is similarly execute din this alternative embodiment.

Although particular embodiments of the present invention have been described above in detail, it will be understood that this description is merely for purposes of illustration. Alternative embodiments of those described hereinabove also are within the scope of the present invention. The above described embodiments of the present invention are presented for purposes of illustration and not of limitation, and the present invention is limited only by the claims which follow.

I claim:

1. A method of providing secure registration with a target website computer comprising:
a user operating a user computer logging into a trusted partner website computer via a computer network by providing trusted partner login credentials;
the trusted partner website computer verifying the user by checking the trusted partner login credentials;
the trusted partner website computer sending a webpage to the user computer comprising a link to a target website computer;
the user computer selecting the link to the target website computer;
the user computer being redirected to the target website computer by the link from the trusted partner website computer, the redirection including a unique secure token that identifies the user computer as being registered with and originating from the trusted partner website computer;
the user computer sending to the target website computer the unique security token;
the target website computer using the token to verify that the user computer was redirected from the trusted partner website computer;
if the target website computer verifies that the user computer was redirected from the trusted partner website computer, then performing the steps of:
the target website computer requesting the user computer to provide registration information,
the user computer sending the requested registration information to the target website computer, the requested registration information comprising an email address of the user,
the target website computer sending a registration email message to the email address provided by the user, the registration email message including a unique registration code,
the user computer displaying a popup window on a screen of the user computer, the popup window providing the unique registration code for viewing by the user,
the user populating the registration code into a form on a registration verification web page and sending the registration verification web page to the target website computer, and
the target website computer verifying the registration code and completing the user registration process.

2. The method of claim 1 wherein the step of the user computer displaying a popup window on a screen of the user computer comprises the target website computer sending a beacon web page to the user computer, the beacon web page comprising a client-side beacon application that scans email messages arriving at the user computer and displays the popup window on the screen of the user computer of the registration email message sent by the target website computer.

3. The method of claim 2 wherein the beacon web page further comprises a permission request control selectable by the user computer, which when selected enables the client-side beacon application to scan the email messages arriving at the user computer.

4. The method of claim 3 wherein the client-side beacon application remains enabled for a predetermined amount of time.

5. The method of claim 2 wherein the client-side beacon application that scans email messages arriving at the user computer by searching for a unique marker embedded in the registration email message sent by the target website computer.

6. The method of claim 5 wherein the unique marker is an originating email address of the email message sent by the target website computer.

7. The method of claim 5 wherein the unique marker is embedded in a subject line of the email message sent by the target website computer.

8. The method of claim 1 wherein trusted partner login credentials comprise a user name and login password.

9. The method of claim 1 wherein trusted partner login credentials comprise biometric information.

10. The method of claim 9 wherein the biometric information comprises fingerprint information input to the user computer by the user.

11. The method of claim 9 wherein the biometric information comprises DNA information input to the user computer by the user.

12. The method of claim 1 wherein the token comprises a unique data string.

13. The method of claim 12 wherein the step of the target website computer using the token to verify that the user was redirected from the trusted partner website computer comprises the target website computer checking the token against a database of valid tokens.

14. The method of claim 12 wherein the step of the target website computer using the token to verify that the user was redirected from the trusted partner website computer comprises the target website computer performing a hash analysis on the token.

15. The method of claim 12 wherein the unique data string is encoded with an identifier of the trusted partner website computer.

16. The method of claim 15 further comprising the step of logging the identifier of the trusted partner website computer in a transaction database.

17. A system comprising:
a user computer operated by a user;
a trusted partner website computer interconnected via a computer network with the user computer; and
a target website computer interconnected via the computer network with the user computer;
wherein the trusted partner website computer is programmed to:
verify the user by checking trusted partner login credentials received from the user computer;
send a webpage to the user computer comprising a link to the target website computer;
redirect the user computer to the target website computer upon selection of the link to the target website computer by the user computer, the redirection including a unique secure token that identifies the user computer as being registered with and originating from the trusted partner website computer; and
wherein the target website computer is programmed to:
use the token received from the user computer to verify that the user computer was redirected from the trusted partner website computer; and
if the target website computer verifies that the user was redirected from the trusted partner website computer, then
request the user computer to provide registration information,
receive the requested registration information, the registration information comprising an email address of the user,
send a registration email message to the email address provided by the user, the registration email message including a unique registration code,
cause the user computer to display a popup window on a screen of the user computer, the popup window providing the unique registration code for viewing by the user,
receive a registration verification web page comprising the registration code populated by the user into a form on the registration verification web page on the user computer, and
verify the registration code and complete the user registration process.

18. The system of claim 17 wherein the target website computer is programmed to cause the user computer to display a popup window on a screen of the user computer by sending a beacon web page to the user computer, the beacon web page comprising a client-side beacon application that scans email messages arriving at the user computer and displays the popup window on the screen of the user computer of the registration email message sent by the target website computer.

19. The system of claim 18 wherein the beacon web page further comprises a permission request control selectable by the user computer, which when selected enables the client-side beacon application to scan the email messages arriving at the user computer.

20. The system of claim 19 wherein the client-side beacon application remains enabled for a predetermined amount of time.

21. The system of claim 18 wherein the client-side beacon application that scans email messages arriving at the user computer by searching for a unique marker embedded in the registration email message sent by the target website computer.

22. The system of claim 21 wherein the unique marker is an originating email address of the email message sent by the target website computer.

23. The system of claim 21 wherein the unique marker is embedded in a subject line of the email message sent by the target website computer.

24. The system of claim 17 wherein trusted partner login credentials comprise a user name and login password.

25. The system of claim 17 wherein trusted partner login credentials comprise biometric information.

26. The system of claim 25 wherein the biometric information comprises fingerprint information input to the user computer by the user.

27. The system of claim 25 wherein the biometric information comprises DNA information input to the user computer by the user.

28. The system of claim 17 wherein the token comprises a unique data string.

29. The system of claim 28 wherein the target website computer is programmed to use the token received from the user computer to verify that the user computer was redirected from the trusted partner website computer by checking the token against a database of valid tokens.

30. The system of claim 28 wherein the target website computer is programmed to use the token received from the user computer to verify that the user computer was redirected from the trusted partner website computer performing a hash analysis on the token.

31. The system of claim 28 wherein the unique data string is encoded with an identifier of the trusted partner website computer.

32. The system of claim 31 wherein the target website computer is further programmed to log the identifier of the trusted partner website computer in a transaction database.

33. A method of providing secure registration with a target website computer comprising:
a target website computer receiving from a user computer a unique security token that identifies the user computer as being registered with and originating from a trusted partner website computer with which the user computer has previously logged in with trusted partner login credentials,
the target website computer using the token to verify that the user computer was redirected from the trusted partner website computer;
if the target website computer verifies that the user computer was redirected from the trusted partner website computer, then the target website computer performing the steps of:
requesting the user computer to provide registration information,
receiving from the user computer the requested registration information, the requested registration information comprising an email address of the user,
sending a registration email message to the email address provided by the user, the registration email message including a unique registration code,
receiving from the user computer a registration verification web page populated at the user computer with the unique registration code as a result of the user computer displaying a popup window on a screen of the user computer, the popup window providing the unique registration code for viewing by the user, and
verifying the registration code and completing the user registration process.

34. The method of claim 33 further comprising the steps of the target website computer sending a beacon web page to the user computer, the beacon web page comprising a client-side beacon application that scans email messages arriving at the user computer and displays the popup window on the screen of the user computer of the registration email message sent by the target website computer.

35. The method of claim 34 wherein the beacon web page further comprises a permission request control selectable by the user computer, which when selected enables the client-side beacon application to scan the email messages arriving at the user computer.

36. The method of claim 35 wherein the client-side beacon application remains enabled for a predetermined amount of time.

37. The method of claim 34 wherein the client-side beacon application that scans email messages arriving at the user computer by searching for a unique marker embedded in the registration email message sent by the target website computer.

38. The method of claim 37 wherein the unique marker is an originating email address of the email message sent by the target website computer.

39. The method of claim 37 wherein the unique marker is embedded in a subject line of the email message sent by the target website computer.

40. The method of claim 33 wherein the token comprises a unique data string.

41. The method of claim 40 wherein the step of the target website computer using the token to verify that the user was redirected from the trusted partner website computer comprises the target website computer checking the token against a database of valid tokens.

42. The method of claim 40 wherein the step of the target website computer using the token to verify that the user was redirected from the trusted partner website computer comprises the target website computer performing a hash analysis on the token.

43. The method of claim 40 wherein the unique data string is encoded with an identifier of the trusted partner website computer.

44. The method of claim 43 further comprising the step of logging the identifier of the trusted partner website computer in a transaction database.

45. A target website computer comprising processing circuitry, input/output circuitry, and program storage, wherein the target website computer is programmed, via instructions in the program storage, to:
receive from a user computer a unique security token that identifies the user computer as being registered with and originating from a trusted partner website computer with which the user computer has previously logged in with trusted partner login credentials,
use the token to verify that the user computer was redirected from the trusted partner website computer;
if the target website computer verifies that the user computer was redirected from the trusted partner website computer, then:
request the user computer to provide registration information,
receive from the user computer the requested registration information, the requested registration information comprising an email address of the user,
send a registration email message to the email address provided by the user, the registration email message including a unique registration code,
receive from the user computer a registration verification web page populated at the user computer with the unique registration code as a result of the user computer displaying a popup window on a screen of the user computer, the popup window providing the unique registration code for viewing by the user, and
verify the registration code and completing the user registration process.

46. The target website computer of claim 45 further programmed to cause the user computer to display a popup window on a screen of the user computer by sending a beacon web page to the user computer, the beacon web page comprising a client-side beacon application that scans email messages arriving at the user computer and displays the popup window on the screen of the user computer of the registration email message sent by the target website computer.

47. The target website computer of claim 46 wherein the beacon web page further comprises a permission request control selectable by the user computer, which when selected enables the client-side beacon application to scan the email messages arriving at the user computer.

48. The target website computer of claim 47 wherein the client-side beacon application remains enabled for a predetermined amount of time.

49. The target website computer of claim 46 wherein the client-side beacon application that scans email messages arriving at the user computer by searching for a unique marker embedded in the registration email message sent by the target website computer.

50. The target website computer of claim 49 wherein the unique marker is an originating email address of the email message sent by the target website computer.

51. The target website computer of claim 49 wherein the unique marker is embedded in a subject line of the email message sent by the target website computer.

52. The target website computer of claim 45 wherein the token comprises a unique data string.

53. The target website computer of claim 52 programmed to use the token to verify that the user was redirected from the trusted partner website computer by checking the token against a database of valid tokens.

54. The target website computer of claim 52 programmed to use the token to verify that the user was redirected from the trusted partner website computer by performing a hash analysis on the token.

55. The target website computer of claim 52 wherein the unique data string is encoded with an identifier of the trusted partner website computer.

56. The target website computer of claim 55 further programmed to log the identifier of the trusted partner website computer in a transaction database.

57. A method of providing secure registration with a target website computer comprising:
a trusted partner website computer receiving trusted partner login credentials from a user operating a user computer for logging into the trusted partner website computer;
the trusted partner website computer verifying the user by checking the trusted partner login credentials;
the trusted partner website computer sending a webpage to the user computer comprising a link to a target website computer to enable the user computer to select the link to the target website computer and be redirected to the target website computer, the redirection including a unique secure token that identifies the user computer as being registered with and originating from the trusted partner website computer.

58. The method of claim 57 wherein trusted partner login credentials comprise a user name and login password.

59. The method of claim 57 wherein trusted partner login credentials comprise biometric information.

60. The method of claim 59 wherein the biometric information comprises fingerprint information input to the user computer by the user.

61. The method of claim 59 wherein the biometric information comprises DNA information input to the user computer by the user.

62. The method of claim 57 wherein the token comprises a unique data string.

63. The method of claim 62 wherein the unique data string is encoded with an identifier of the trusted partner website computer.

64. A trusted partner website computer comprising processing circuitry, input/output circuitry, and program storage, wherein the trusted partner website computer is programmed, via instructions in the program storage, to:
receive trusted partner login credentials from a user operating a user computer for logging into the trusted partner website computer;
verify the user by checking the trusted partner login credentials; and
send a webpage to the user computer comprising a link to a target website computer to enable the user computer to select the link to the target website computer and be redirected to the target website computer, the redirection including a unique secure token that identifies the user computer as being registered with and originating from the trusted partner website computer.

65. The trusted partner website computer of claim 64 wherein trusted partner login credentials comprise a user name and login password.

66. The trusted partner website computer of claim 64 wherein trusted partner login credentials comprise biometric information.

67. The trusted partner website computer of claim 66 wherein the biometric information comprises fingerprint information input to the user computer by the user.

68. The trusted partner website computer of claim 66 wherein the biometric information comprises DNA information input to the user computer by the user.

69. The trusted partner website computer of claim 64 wherein the token comprises a unique data string.

70. The trusted partner website computer of claim 69 wherein the unique data string is encoded with an identifier of the trusted partner website computer.

71. A method of a user computer establishing secure registration with a target website computer comprising:
a user operating a user computer logging into a trusted partner website computer via a computer network by providing trusted partner login credentials;
the user computer receiving from the trusted partner website computer, after the trusted partner website computer has verified the user by checking the trusted partner login credentials, a webpage comprising a link to a target website computer;
the user computer selecting the link to the target website computer;
the user computer being redirected to the target website computer by the link from the trusted partner website computer, the redirection including a unique secure token that identifies the user computer as being registered with and originating from the trusted partner website computer;
the user computer sending to the target website computer the unique security token for verification that the user computer was redirected from the trusted partner website computer;
the user computer receiving a request from the target website computer for the user computer to provide registration information,
the user computer sending the requested registration information to the target website computer, the requested registration information comprising an email address of the user,
the user computer receiving a registration email message at the email address provided by the user, the registration email message including a unique registration code,
the user computer displaying a popup window on a screen of the user computer, the popup window providing the unique registration code for viewing by the user,
the user populating the registration code into a form on a registration verification web page and sending the registration verification web page to the target website computer for verification and completion of the user registration process.

72. The method of claim 71 further comprising the steps of the user computer receiving a beacon web page from the target website computer, the beacon web page comprising a client-side beacon application that scans email messages arriving at the user computer and displays the popup window on the screen of the user computer of the registration email message sent by the target website computer.

73. The method of claim 72 wherein the beacon web page further comprises a permission request control selectable by the user computer, which when selected enables the client-side beacon application to scan the email messages arriving at the user computer.

74. The method of claim 73 wherein the client-side beacon application remains enabled for a predetermined amount of time.

75. The method of claim 72 wherein the client-side beacon application that scans email messages arriving at the user computer by searching for a unique marker embedded in the registration email message sent by the target website computer.

76. The method of claim 75 wherein the unique marker is an originating email address of the email message sent by the target website computer.

77. The method of claim 75 wherein the unique marker is embedded in a subject line of the email message sent by the target website computer.

78. The method of claim 71 wherein trusted partner login credentials comprise a user name and login password.

79. The method of claim 71 wherein trusted partner login credentials comprise biometric information.

80. The method of claim 79 wherein the biometric information comprises fingerprint information input to the user computer by the user.

81. The method of claim 79 wherein the biometric information comprises DNA information input to the user computer by the user.

82. The method of claim 71 wherein the token comprises a unique data string.

83. The method of claim 82 wherein the unique data string is encoded with an identifier of the trusted partner website computer.

84. A user computer comprising processing circuitry, input/output circuitry, and program storage, wherein the user computer is programmed, via instructions in the program storage, to:
log into a trusted partner website computer via a computer network by providing trusted partner login credentials;
receive from the trusted partner website computer, after the trusted partner website computer has verified the user by checking the trusted partner login credentials, a webpage comprising a link to a target website computer;
select the link to the target website computer;
be redirected to the target website computer by the link from the trusted partner website computer, the redirection including a unique secure token that identifies the user computer as being registered with and originating from the trusted partner website computer;
send to the target website computer the unique security token for verification that the user computer was redirected from the trusted partner website computer;
receive a request from the target website computer for the user computer to provide registration information,
send the requested registration information to the target website computer, the requested registration information comprising an email address of the user,
receive a registration email message at the email address provided by the user, the registration email message including a unique registration code,
display a popup window on a screen of the user computer, the popup window providing the unique registration code for viewing by the user, and
populate the registration code into a form on a registration verification web page and sending the registration verification web page to the target website computer for verification and completion of the user registration process.

85. The user computer of claim 84 further programmed to receive a beacon web page from the target website computer, the beacon web page comprising a client-side beacon application that scans email messages arriving at the user computer and displays the popup window on the screen of the user computer of the registration email message sent by the target website computer.

86. The user computer of claim 85 wherein the beacon web page further comprises a permission request control selectable by the user computer, which when selected enables the client-side beacon application to scan the email messages arriving at the user computer.

87. The user computer of claim 86 wherein the client-side beacon application remains enabled for a predetermined amount of time.

88. The user computer of claim 85 wherein the client-side beacon application that scans email messages arriving at the user computer by searching for a unique marker embedded in the registration email message sent by the target website computer.

89. The user computer of claim 88 wherein the unique marker is an originating email address of the email message sent by the target website computer.

90. The user computer of claim 88 wherein the unique marker is embedded in a subject line of the email message sent by the target website computer.

91. The user computer of claim 84 wherein trusted partner login credentials comprise a user name and login password.

92. The user computer of claim 84 wherein trusted partner login credentials comprise biometric information.

93. The user computer of claim 92 wherein the biometric information comprises fingerprint information input to the user computer by the user.

94. The user computer of claim 92 wherein the biometric information comprises DNA information input to the user computer by the user.

95. The user computer of claim 84 wherein the token comprises a unique data string.

96. The user computer of claim 95 wherein the unique data string is encoded with an identifier of the trusted partner website computer.

97. A method of providing secure registration with a target website computer comprising:
a user operating a user computer logging into an originating website computer via a computer network by providing originating website login credentials;
the originating website computer verifying the user by checking the originating website login credentials;
the originating website computer sending a webpage to the user computer comprising a link to a target website computer;
the user computer selecting the link to the target website computer;
the user computer being redirected to the target website computer by the link from the originating website computer, the redirection including a unique secure token that identifies the user computer as being registered with and originating from the originating website computer;
the user computer sending to the target website computer the unique security token;
the target website computer using the token to verify that the user computer was redirected from the originating website computer by
sending a user verification query to a trusted third party service computer, the query comprising the token,
the trusted third party service computer using the token to verify that the user computer was redirected from the originating website computer, and
the trusted third party service computer sending a user verification confirmation message to the target website computer;
if the target website computer verifies that the user computer was redirected from the originating website computer, then performing the steps of:
the target website computer requesting the user computer to provide registration information,
the user computer sending the requested registration information to the target website computer, the requested registration information comprising an email address of the user,
the target website computer sending a registration email message to the email address provided by the user, the registration email message including a unique registration code,
the user computer displaying a popup window on a screen of the user computer, the popup window providing the unique registration code for viewing by the user,
the user populating the registration code into a form on a registration verification web page and sending the registration verification web page to the target website computer, and
the target website computer verifying the registration code and completing the user registration process.

98. The method of claim 97 wherein the step of the user computer displaying a popup window on a screen of the user computer comprises the target website computer sending a beacon web page to the user computer, the beacon web page comprising a client-side beacon application that scans email messages arriving at the user computer and displays the popup window on the screen of the user computer of the registration email message sent by the target website computer.

99. The method of claim 98 wherein the beacon web page further comprises a permission request control selectable by the user computer, which when selected enables the client-side beacon application to scan the email messages arriving at the user computer.

100. The method of claim 99 wherein the client-side beacon application remains enabled for a predetermined amount of time.

101. The method of claim 98 wherein the client-side beacon application that scans email messages arriving at the user computer by searching for a unique marker embedded in the registration email message sent by the target website computer.

102. The method of claim 101 wherein the unique marker is an originating email address of the email message sent by the target website computer.

103. The method of claim 101 wherein the unique marker is embedded in a subject line of the email message sent by the target website computer.

104. The method of claim 97 wherein the originating website login credentials comprise a user name and login password.

105. The method of claim 97 wherein the originating website login credentials comprise biometric information.

106. The method of claim 105 wherein the biometric information comprises fingerprint information input to the user computer by the user.

107. The method of claim 105 wherein the biometric information comprises DNA information input to the user computer by the user.

108. The method of claim 97 wherein the token comprises a unique data string.

109. The method of claim 108 wherein the step of the trusted third party service computer using the token to verify that the user computer was redirected from the originating website computer comprises the trusted third party service computer checking the token against a database of valid tokens.

110. The method of claim 108 wherein the step of the trusted third party service computer using the token to verify that the user was redirected from the originating website computer comprises the trusted third party service computer performing a hash analysis on the token.

111. The method of claim 108 wherein the unique data string is encoded with an identifier of the originating website computer.

112. The method of claim 111 further comprising the step of logging the identifier of the originating website computer in a transaction database.

113. A system comprising:
a user computer operated by a user;
an originating website computer interconnected via a computer network with the user computer;
a target website computer interconnected via the computer network with the user computer;
a trusted third party service computer interconnected via the computer network with the target website computer; and
wherein the originating website computer is programmed to:
verify the user by checking originating website login credentials received from the user computer;
send a webpage to the user computer comprising a link to the target website computer;
redirect the user computer to the target website computer upon selection of the link to the target website computer by the user computer, the redirection including a unique secure token that identifies the user computer as being registered with and originating from the originating website computer; and
wherein the target website computer is programmed to:
use the token received from the user computer to verify that the user computer was redirected from the originating website computer by
sending a user verification query to a trusted third party service computer, the query comprising the token, and
receiving from the trusted third party service computer a user verification confirmation message after the trusted third party service computer uses the token to verify that the user computer was redirected from the originating website computer; and
if the target website computer verifies that the user was redirected from the trusted partner website computer, then
request the user computer to provide registration information,
receive the requested registration information, the registration information comprising an email address of the user,
send a registration email message to the email address provided by the user, the registration email message including a unique registration code,
cause the user computer to display a popup window on a screen of the user computer, the popup window providing the unique registration code for viewing by the user,
receive a registration verification web page comprising the registration code populated by the user into a form on the registration verification web page on the user computer, and
verify the registration code and complete the user registration process.

114. The system of claim 113 wherein the target website computer is programmed to cause the user computer to display a popup window on a screen of the user computer by sending a beacon web page to the user computer, the beacon web page comprising a client-side beacon application that scans email messages arriving at the user computer and displays the popup window on the screen of the user computer of the registration email message sent by the target website computer.

115. The system of claim 114 wherein the beacon web page further comprises a permission request control selectable by the user computer, which when selected enables the client-side beacon application to scan the email messages arriving at the user computer.

116. The system of claim 115 wherein the client-side beacon application remains enabled for a predetermined amount of time.

117. The system of claim 114 wherein the client-side beacon application that scans email messages arriving at the user computer by searching for a unique marker embedded in the registration email message sent by the target website computer.

118. The system of claim 117 wherein the unique marker is an originating email address of the email message sent by the target website computer.

119. The system of claim 117 wherein the unique marker is embedded in a subject line of the email message sent by the target website computer.

120. The system of claim 113 wherein originating website login credentials comprise a user name and login password.

121. The system of claim 113 wherein originating website login credentials comprise biometric information.

122. The system of claim 121 wherein the biometric information comprises fingerprint information input to the user computer by the user.

123. The system of claim 121 wherein the biometric information comprises DNA information input to the user computer by the user.

124. The system of claim 113 wherein the token comprises a unique data string.

125. The system of claim 124 wherein the trusted third party service computer uses the token received from the user computer to verify that the user computer was redirected from the originating website computer by checking the token against a database of valid tokens.

126. The system of claim 124 wherein the trusted third party service computer uses the token received from the user computer to verify that the user computer was redirected from the originating website computer by performing a hash analysis on the token.

127. The system of claim 124 wherein the unique data string is encoded with an identifier of the originating website computer.

128. The system of claim 127 wherein the target website computer is further programmed to log the identifier of the trusted partner website computer in a transaction database.
